(19) United States
(12) Patent Application Publication
(10) Pub. No.: US 2017/0330249 A1
(43) Pub. Date: Nov. 16, 2017

(54) SYSTEM AND METHOD FOR PROVIDING AUTOMATED ONLINE DONATION SERVICES FOR A STUDENT ASSOCIATED WITH AN EDUCATIONAL INSTITUTION

(71) Applicant: Trina Celise, Culver City, CA (US)

(72) Inventor: Trina Celise, Culver City, CA (US)

(21) Appl. No.: 15/154,175

(22) Filed: May 13, 2016

(51) Int. Cl. G06Q 30/02; G06F 17/30; G06Q 40/02; G06Q 20/10

(52) U.S. Cl. CPC G06Q 30/0279; G06Q 40/025; G06Q 20/10; G06F 17/30377; G06F 17/3053; G06F 17/30867

(57) ABSTRACT

A system and a method for providing automated online donation services for a student associated with an educational institution. The method includes searching for a student data in a plurality of student profiles in a student database in view of one of a query received from a donor or information stored in a donor profile. The method also includes generating a list of students and corresponding student profiles in view of the search. The method also includes ranking the corresponding student profiles based on the student data in each of the corresponding student profiles and sending the list of students, the corresponding student profiles and the corresponding ranking to the donor. The method further includes receiving from the donor a selection of a student from the list of students and processing a donation for the selected student.

### FIELD OF THE INVENTION

The present invention relates to a system and method for providing automated online donation services for a student associated with an educational institution.

### BACKGROUND OF THE INVENTION

With rising costs of education, many students require financial assistance in paying for their education, whether it be in the form of grants, scholarships, special employment (e.g., work-study programs), and/or loans. Many such educational institutions (e.g., schools, such as colleges and universities) provide various forms of assistance in obtaining financial aid for potential students.

Currently, conventional means for providing financial assistance requires students to seek for various grants, scholarships, work-study programs, or types of awards and apply individually to each of awards. In addition, even applying for these awards does not guarantee that the student will receive any award. Further, many students are not able to apply for such awards as they do not fulfill the requirements to be eligible for the awards. While many students may receive grants, scholarships or other funding that does not require repayment, the majority of college-attending students are obligated to accept the burden of interest-bearing student loans. At the completion of a four-year degree, the student may face graduation with a diploma in one hand and tens of thousands of dollars or more in interest-bearing student loans.

There is a multitude of generous individuals and companies who would be quick to offer those students all or part of the financial assistance needed to help them succeed. However, the current methods of identifying those students or providing financial assistance is unsystematic. Moreover, many donors that wish to grant assistance to students do not have a clear and secure method of identifying those students in need of financial assistance, nor do they have a clear and secure method of funding those students.

### BRIEF DESCRIPTION OF THE DRAWINGS

FIG. 1 is a block diagram of an architecture for providing automated online donation services for a student associated with an educational institution in accordance with an embodiment of the present invention;

FIG. 2 is a block diagram of a service provider component of FIG. 1 in accordance with an embodiment of the present invention.

FIG. 3A is a flow chart illustrating a method for providing automated online donation services for a student associated with an educational institution in accordance with an embodiment of the present invention.

FIG. 3B is a flow chart illustrating a method for providing automated online donation services for a student associated with an educational institution in accordance with an embodiment of the present invention.

FIG. 4 illustrates a block diagram of one embodiment of a computer system.

### DETAILED DESCRIPTION OF THE INVENTION

Embodiments of the present invention describe a system that provides automated online donation services for a student associated with an accredited educational institution in the United States. In one embodiment, both students and donors register with a service provider. The service provider enables the donor to retrieve a list of students and their profiles, and to select a student to provide a donation. The donation may be provided to an educational institution in which the student is committed and enrolled on behalf of the student. In addition, the service provider may periodically or continually update the student profile for the student, and maintain this updated student profile for the donor to review.

Embodiments of the present invention provide several advantages over existing student funding options. One such advantage is that the method provides a singular dedicated mechanism for providing funding for the education of students. Another advantage is that embodiments of the present invention provide additional funding sources that the students did not previously have available to them. Further, embodiments also allow the donors to easily select the students who are eligible to receive the awards for donation and to provide funding to the service provider to be forwarded to the educational institution or directly to the student, as the donor designates.

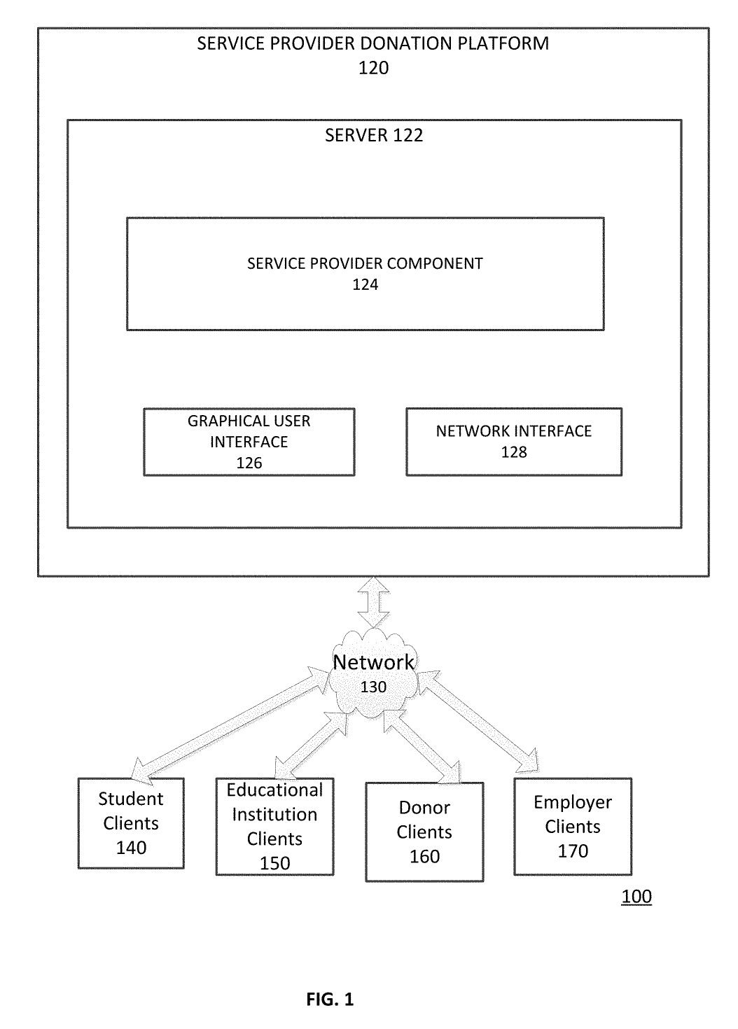

Referring to FIG. 1, there is illustrated a block diagram of a client-server network architecture 100 for providing automated online donation services for a student associated with an educational institution, in accordance with an embodiment of the invention. More particularly, the network architecture 100 includes a computing platform such as a service provider donation platform 120 comprising a network server (server) 122 communicably coupled to a network 130. In one embodiment, the network 130 is a local area network (LAN) or a wide area network (WAN) such as the Internet. However, any computer network is considered within the scope of the invention. The server 122 includes a service provider component 124, a graphical user interface 126 and a network interface (input/output circuit) 128. The network interface 128 may be coupled to the service provider component 124, and may be operable to send and receive data over the network 130. The service provider component 124 may be a software module executed from instructions stored in a memory (not shown).

Student clients 140, educational institution clients 150, donor clients 160 and employer clients 170 may access a website established by the server 122 through the network 130 via a computing device including a laptop computer, a handheld computer, a netbook, a smart phone, a desktop, a workstation, a server device, a mainframe, or any other similar computing device. A student client 140 may be any user who committed to attend an educational institution and seeks financial assistance for attendance at the educational institution. An educational institutional client 150 may be any accredited institution that provides education to students. A donor client 160 may be an individual or an organization that donates funds to the educational institution on behalf of a student. An employer client 170 may be an individual or an organization that provides employment opportunities to the student clients 140.

In one embodiment, the service provider component 124 processes donations for student clients 140 associated with the educational institution clients 150. The student client 140 may be associated with the educational institution client 150 such that the student client 140 is committed or enrolled to attend at least one semester of classes provided by the educational institutional client 150. In one embodiment, the service provider component 124 receives a query from the donor client 160 to search for one or more students clients 140. The query includes a data element including a criterion for at least one of a name of educational institution, major area of study, minor area of study, community involvement of students, volunteer data of students and work experience of students. In one embodiment, the service provider component 124 searches for student profiles in response to the data element in the query to identify students matching criteria in the data element. The service provider component 124 generates a list of students whose student profiles match the criteria in the data element in the query. The student profile may include student data including but not limited to a student identification, current photo of the student, name of an educational institution the student has committed to attend, a major area of study, a minor area of study, student's transcripts or record of grades, financial status of the student, requested financial assistance needed for the student's education for a specific semester in the educational institution, background data, family data, community involvement, volunteer data, work experience, etc.

In one embodiment, the student clients 140 register with the service provider component 124 including providing the student profile. In one embodiment, the educational institutional clients 150 verify the student profile and receive the funds from the service provider component 124 for the student clients 140. In one embodiment, the donor clients 160 register with the service provider component 124 including providing a donor profile, querying the student profile in the service provider component 124 to select a student client 140 for donation of the funds to the educational institutional client 150. In one embodiment, the employer client 170 registers with the service provider component 124 including providing an employer profile.

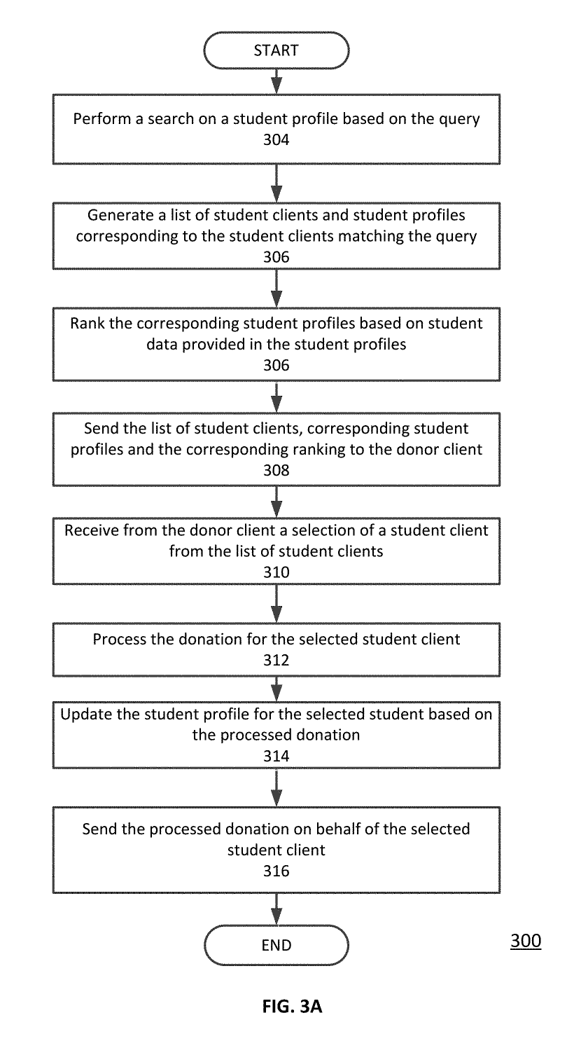

FIG. 2 is a block diagram illustrating details of the service provider component 124 of FIG. 1. As discussed above, the service provider component 124 processes donations to a student associated with an educational institution In one embodiment, the service provider component 124 processes the donations as instructed by the donor client 160.

In one embodiment, the service provider component 124 includes a student provider module 220 including a student registration module 222, a student verification module 224, and a student database 226. In one embodiment, the student clients 140 register with the student registration module 222. To register with the service provider donation platform 120, the student clients 140 fill out a student profile and send the student profile to service provider component 124. In one embodiment, students fill out the student profile via a fillable form provided by a web page served by the student provider module 220. The student profile may include student data including but not limited to a student identification, a current photo of the student, student contact data, a name of an educational institution the student has committed to attend, a major area of study, a minor area of study, a transcript, a financial status of the student, requested financial assistance needed for the student's education for a specific semester in the educational institution, background data, family data, community involvement, volunteer data, work experience, etc. Students may also write introductions, memos, etc. that request funding for specific purposes, indicate hardships the student has overcome or is presently experiencing, and/or that provides additional information that might be relevant to donors. Students may also be required to provide personal information such as social security number, date of birth, and so on.

In one embodiment, the student verification module 224 identifies the educational institution provided in the student profile and sends the student profile (or a portion of the student profile) to the educational institution client 150 associated with the educational institution to verify the student profile (or the portion of the student profile). In one embodiment, the student verification module 224 verifies the student profile by retrieving a student record from the educational institution client 150 and comparing the student record with the student profile. The student verification module 224 may access the student record stored in the educational institutional client 150 upon permission authorized by the educational institution client 150 and the student client 140. The student verification module 224 may receive the student record from the educational institution client 150 upon permission authorized by the student client 140 In one embodiment, the student record includes data similar to the student profile. The student record includes, but is not limited to, the student identification, the current photo of the student, student contact data, name of an educational institution the student has committed to attend, major area of study, minor area of study, transcript, financial status of the student, requested financial assistance needed for the student's education for a specific semester in the educational institution, background data, family data, community involvement, volunteer data, work experience, etc.

Upon comparison between the student profile and student record, the student verification module 224 determines whether a match exists between the student data in the student profile and the student data in the student record, and whether there are any discrepancies between the student record and the student profile. In one embodiment, the student verification module 224 determines that a match does not exist when data compared between the student record and the student data in the student profile is outside a threshold. In one embodiment, the threshold includes a number of the discrepancies that exist between the student record and the student profile. Such number may be two or more.

When there is a mismatch between data in the student profile and data in the student record, the student verification module 224 notifies the student client 140 that the student profile for that student client 140 cannot be completed because of inaccurate data. In such scenario, the student client 140 may check on the student record stored with the educational institution client 150 and update the student record. The student client 140 may re-register with the student registration module 222.

In one embodiment, the student verification module 224 determines that a match does exist when the data compared between the student record and the student data in the student profile is within a threshold. Upon determination of the match, the student verification module 224 sends the student client 140 a student agreement for review and signature. The student agreement may include a statement in which the student client 140 agrees that any donation from a donor client 160 will convert to a student loan if the student client 140 does not meet a certain criteria. Such criteria may include but are not limited to the student maintaining a minimum grade point average, the student meeting graduation requirements, the student continuing to attend the educational institution until graduation, and so on. After receipt of the signed agreement from the student client 140, the student verification module 224 stores the student profile along with the signed student agreement in a student database 226 and notify the student client 140 of confirmation of the student registration.

In one embodiment, the service provider component 124 includes a donor provider module 230 including a donor registration module 232 and a donor database 234. In one embodiment, the donor clients 160 register with the donor registration module 232. Such registration may require the donor clients 160 to provide a donor profile. The donor profile may include but is not limited to a donor name, donor contact data, a type of business associated with the donor, anonymous or recognized donor and/or other information. The donor profile may additionally indicate a maximum and/or minimum amount of funds the donor is willing to contribute to a student attending an educational institution. The donor profile may additional include one or more donation criteria of the donor. For example, the donor criteria may identify one or more educational institutions to which the donor wishes to contribute funds on behalf of the students. The donor criteria may identify one or more majors or minors of study by students for which the donor wishes to contribute funds to the educational institution on behalf of those students. The donor criteria may require a student to have a minimum or maximum range of grade point average in the transcript in order for the donor to contribute funds to the educational institution on behalf of those students. The donor criteria may identify one of background data, family data, community involvement, volunteer experience or work experience or combinations for the student as a requirement for the donor to contribute funds to the educational institution on behalf of those students. The donor criteria may require a student having a certain financial requirement for the donor to contribute funds to the educational institution on behalf of those students.

In one embodiment, the registration of the donor also includes the donor registration module 232 providing the donor clients 160 with a donor agreement for review and signature. Such donor agreement may include some guidelines and conduct to be agreed and followed by the donor clients 160. After receipt of the signed donor agreement from the donor clients 160, the donor profile along with the corresponding signed donor agreement is stored in the donor database 234.

In one embodiment, the service provider component 124 includes a donation processing module 240 including a search module 242 a payment module 244 and a loan conversion module 246. In one embodiment, the search module 242 automatically searches the student profile to retrieve a listing of a plurality of student clients 140. The search module 242 may search the student profile based on the information provided in the donor profile. As discussed above, such information may include the one or more donation criteria. In one embodiment, the donor client 160 sends a query to the student database 226 to search for one or more student clients 140. The query includes data elements including but not limited to a name of an educational institution a student client is enrolled to attend, major area of study, minor area of study, financial status of the student client, community involvement, volunteer data, work experience, etc. The search module 242 performs a search in the student database 226 using the data elements in the query. In one embodiment, the search module 242 compares the data elements in the query with the student data in some or all student profiles stored in the database 226 and generates a search result listing student clients 140 whose student data in the student profile match with one or more of the data elements in the query. In one embodiment, the search module 242 provides the listing of the plurality of student clients 140 to the donor client 160. In one embodiment, the search module 242 displays the listing of the plurality of student clients 140 via the GUI 126.

In one embodiment, the service provider component 124 ranks the student profiles of the student clients 140. The student profiles may be ranked based on student data such as major area of study, a minor area of study, a transcript, a financial status of the student, requested financial assistance needed for the student's education for a specific semester in the educational institution, background data, family data, community involvement, volunteer data, work experience, etc. In one embodiment, the service provider component 124 provides the ranking of the student profiles along with the listing of the plurality of student clients 140. In one embodiment, the service provider component 124 returns a listing of one or more student clients among the plurality of student clients 140 to the donor client 160 to donate the funds based on the ranking of the student profile. In one embodiment, the service provider component 124 orders the student profiles based on their ranking, and provides a subset of the ordered student profiles to the donor client. The subset may include, for example, the 10 student profiles with the highest rank according to the donor's query.

In one embodiment, the donor client 160 selects all the student clients among the list of plurality of student clients 140 to donate the funds to their corresponding educational institutional client 150. In one embodiment, the donor client 160 selects one or more student clients 140 from the list of plurality of student clients 140 for donation of funds to the educational institution client 150 for each of the selected student clients 140. The one or more student clients 140 may be selected based on the ranking of their student profile. In one embodiment, the donor clients 160 donate a specific amount of funds towards the requested financial assistance for a specific semester in the educational institution for the selected student clients 140. In one embodiment, the amount of money is determined based on total amount of funds provided by the donor client 160. The donor client 160 may wish to distribute total amount of funds evenly to the selected student clients 140. The donor client 160 may wish to distribute the total amount of funds to the selected student clients 140 based on the ranking in their corresponding student profile. In one embodiment, the donor client 160 donates full amount of money towards the requested financial assistance needed for the specific semester in the educational institution for the selected student client 140. In one embodiment, the payment module 244 processes the donation for the student client 140 selected by the donor client 160. The payment module 244 may process the donation by verifying a payment method provided by the donor client 160. In one embodiment, the payment method is stored in the donor profile. In one embodiment, the payment method is received from the donor client at the time of processing the donation. Such payment method may include but is not limited to debit cards, charge cards, prepaid cards, direct debit, bank transfer, money order, check etc. Upon the verification of the payment method, the payment module 244 may remit payment for the donation. In one embodiment, after processing of the donation, the donation processing module 240 retrieves name, contact information of the educational institution client 150 corresponding to the selected student client 140, and remits the payment for the donation on behalf of the selected student client 140 to the corresponding educational institution client 150. The donation may be sent via electronic payment or check to the corresponding educational institution client 150. In one embodiment, the donation processing module 240 provides the processed donation to the educational institution client 150 for the selected student for a payment of items incurred by the selected student for educational related expense. In one embodiment, the donation processing module 240 provides the processed donation to the educational institution client 150 for the selected student for payment of future costs for the selected student for the educational related expense. In one embodiment, the processed donation is sent directly to the selected student client. preferably to a bank account of the selected student client. In one embodiment, the processed donation is sent to a debtor to pay off at least a portion of an educational loan to the student.

In one embodiment, the donation processing module 240 notifies the selected student client 140 of the donation provided on behalf of the selected student client 140. The selected student client 140 may be informed of the donation via e-mail, text, voice call, social network accounts, or combinations thereof. In one embodiment, the donation processing module 240 informs the selected student client 140 of the donation without providing any profile of the donor client 160 since the donor profile includes anonymous donor. In one embodiment, donation processing module 240 informs the selected student client 140 of the donation and the donor profile of the donor client 160. In one embodiment, after processing of the donation, the donation processing module 240 remits payment for the donation directly to the selected student client 140. In one embodiment, the service provider component 124 checks the donor profile to determine whether the donor client 160 is anonymous donor or a recognized donor. When it is determined that the donor client 160 is a recognized donor and has successfully completed a donation, then the service provider component 124 sends a thank you response to the donor client 160. In one embodiment, the service provider 124 may deduct from a donation, an agreed upon service charge for administrative costs and/or processing fees before transferring donated funds to the student client 140 or the educational institution client 150.

In one embodiment, the donation processing module 240 notifies the student provider module 220 of the donation provided to the educational institution client 150. In one embodiment, the student provider module 220 updates the student profile stored in the student database 226 based on the donation. The student provider module 220 may add name of the donor client and the amount of donation provided to the educational institution client in the student profile. The student provider module 220 may update the requested financial assistance needed for the students' education for a specific semester in the student profile based on the donation. In one embodiment, the student provider module 220 notifies the student client 140 of the updated student profile. In one embodiment, the student provider module 220 notifies the educational institution client 150 of the updated student profile. In one embodiment, the student provider module 220 notifies the donor client 160 of the updated student profile.

In one embodiment, student provider module 220 updates the student profile stored in the student database 226 based on an updated student data received from the student client 140. In one embodiment, student provider module 220 updates the student profile stored in the student database 226 based on updated student data received from the educational institution client 150. Some examples of the student data updated in the student profile may include updated transcript for the semester change of the educational institution the student is committed to attend, change in major, change in minor etc. In one embodiment, the student provider module 220 determines that the updated student profile is for the student client 140 selected by the donor client 160 for the donation. In one embodiment, the student provider module 220 sends a notice to the donor client 160 that the selected client 140 has updated their student profile.

In one embodiment, the student provider module 220 monitors the student profile stored in the student database 226. The student provider module 220 may determine that the updated student profile includes update in the student data for the student client 140 selected for donation. In one embodiment, the update in the student data may include a change in one of an educational institution a student client is enrolled to attend, major area of study, minor area of study, transcript, financial status of the student client, community involvement, volunteer experience, work experience, etc. In one embodiment, the student provider module 220 sends to the loan conversion module 246 this updated student profile for the student client 140 receiving the donation from the donor client 160. In one embodiment, the loan conversion module 246 checks with the donor provider module 230 whether the updated student profile for the student client 140 satisfies the donor criteria stored in the donor profile. The donor provider module 230 compares the updated profile of the student client 140 with the donor criteria. When it is determined that the updated student profile satisfies the donor criteria, then the donation continues to be sent on behalf of the student client 140. However, when it is determined that the updated student profile does not satisfy the donor criteria, then the donor provider module 240 may send a warning to the student client 140 for not satisfying the donor criteria and providing a grace period to the student client 140 to satisfy the donor criteria. The donor provider module 240 retrieves the updated student profile from the student provider module 220 after the grace period. In one embodiment, when the donor provider module 240 determines that the updated student profile satisfies the donor criteria after the grace period, the payment module 244 continues to send the donation on behalf of the student client 140. In one embodiment, when the donor provider module 240 determines that the updated student profile does not meet the donor criteria after the grace period, the loan conversion module 246 converts the donation to a loan. In one embodiment, the payment module 244 processes the loan for the student client 140 in a similar mechanism described above with respect to the processing the donation. In one embodiment, the donation processing module 240 provides the processed loan to the educational institution client 150 for the student client 140 for payment of future costs for the student for the educational expense. In one embodiment, the donation processing module 240 notifies the student client 140 of the conversion of the donation to the loan provided to the educational institution client 150.

In one embodiment, the funds for donation by the donor client 160 are undesignated funds that are not to be donated to a specific student client 140. The donor client 160 may authorize service provider component 124 to apply these undesignated funds in various ways. In one embodiment, the service provider component 124 may process these undesignated funds to be applied to a department in the educational institution client 150. In another embodiment, the service provider component 124 may process these undesignated funds to be applied to an administration in the educational institution client 150. In a further embodiment, the service provider component 124 may process these undesignated funds to be applied to a student selected by the educational institution client 150. The embodiments discussed above are just some examples of different methods to apply the processed undesignated funds, one of ordinary skill in the art can appreciate that there can be many other methods to apply the processed undesignated funds.

In one embodiment, the service provider component 124 includes an employer provider module 250 including an employer registration module 252 and an employer database 254. In one embodiment, the employer clients 170 register with the employer registration module 252. Such registration may request that the employer clients 170 to provide an employer profile. Such employer profile may include but is not limited to a name and address of a company associated with the employer client, a type of the company, a contact name of the company, a list of employment opportunities available including position title, location, duration, salary, benefits and other pertinent information associated with the available employment opportunities. In one embodiment, the registration also includes the employer registration module 252 providing the employer clients 160 with an employer agreement for review and signature. Such employer agreement may include some guidelines and conducts to be accepted and followed by the employer clients 160. Upon receipt of the signed employer agreement from the employer clients 170, the employer profile along with the corresponding signed employer agreement is stored in the employer database 254. In one embodiment, the student clients 140 are informed of the employment opportunities posted by the employer client 170 in the employer profile. The student clients 140 may be informed via e-mail, text, etc. In one embodiment, the student clients 140 may query for a search of the employment opportunities in the employer profile stored in the employer database 254.

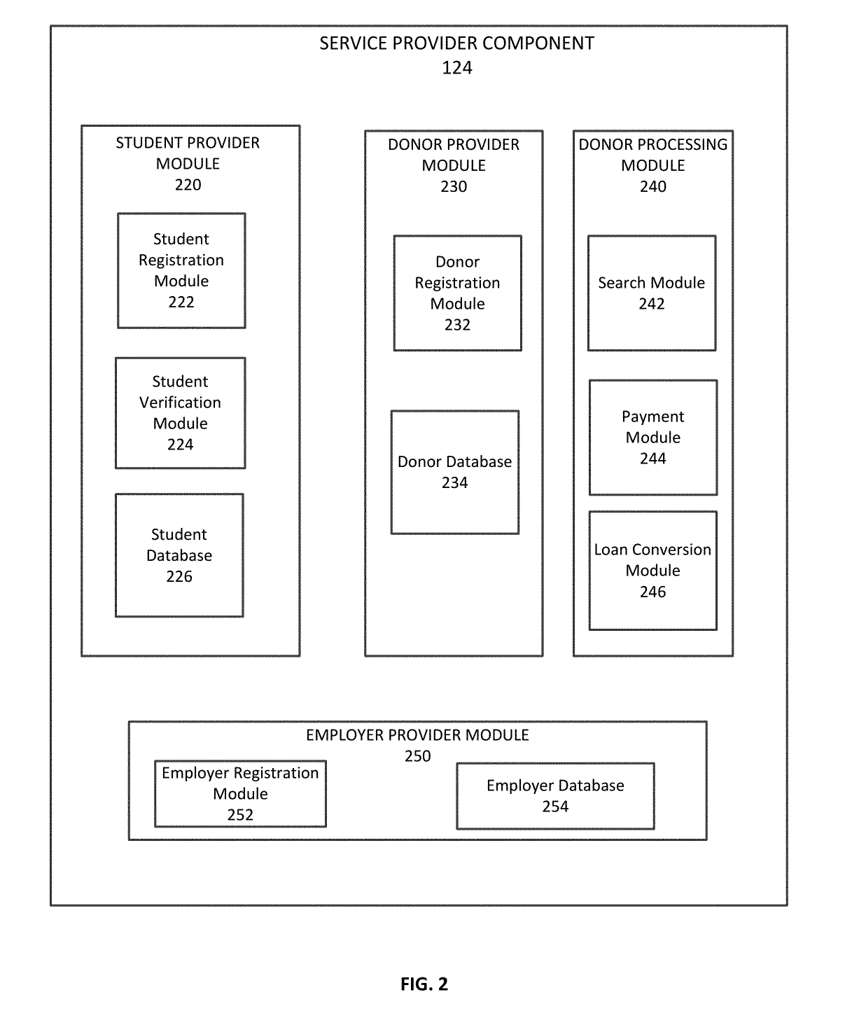

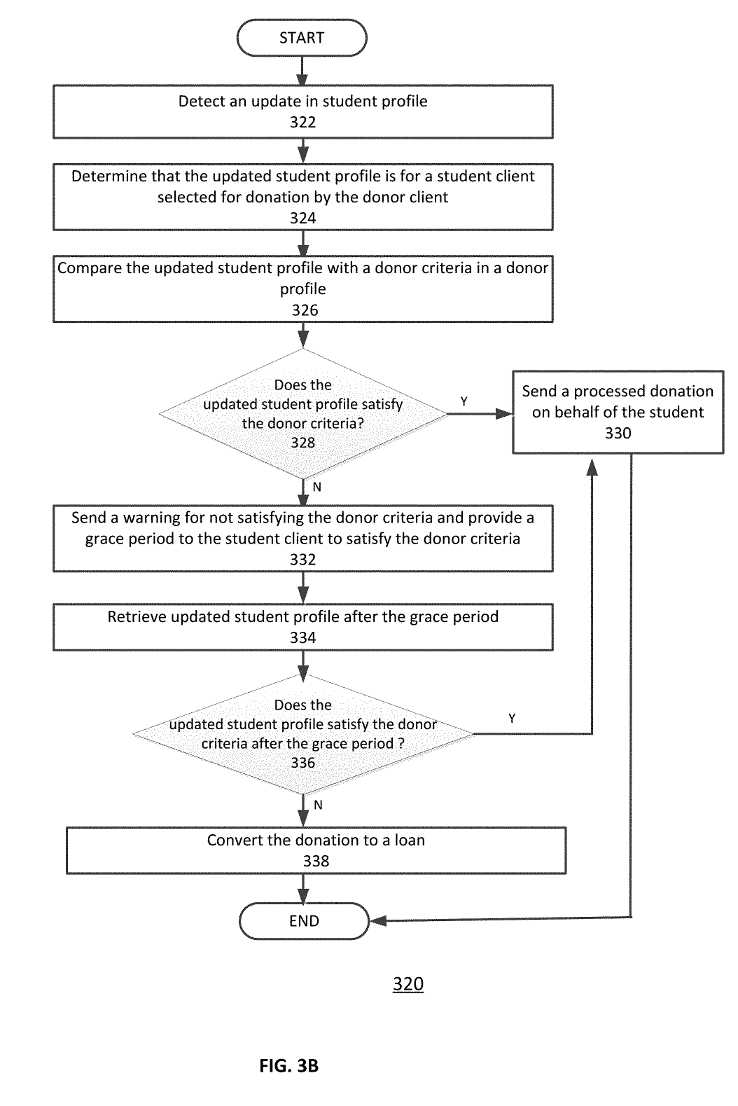

FIG. 3A is a flow chart illustrating a method 300 for providing automated online donation services for a student associated with an educational institution in accordance with an embodiment of the present invention. Method 300 may be performed by processing logic that may comprise hardware (e.g., circuitry, dedicated logic, programmable logic, microcode, etc.), software (such as instructions run on a processing device), firmware, or a combination thereof. In one embodiment, the method 300 is performed by the service provider component 124 of FIG. 1 and FIG. 2.

The method 300 begins at block 302, a search is performed on a student profile. In one embodiment, the search is done based on a query to search for one or more student clients is received from a donor client. The query includes data elements which may include, but is not limited to, name of an educational institution, major area of study, minor area of study, community involvement, volunteer data, work experience, etc. In one embodiment, the search is automatically performed based on information provided in the donor profile. As discussed above, such information may include but is not limited to a donor name, donor contact data, a type of business associated with the donor, anonymous or recognized donor and/or other information. The donor profile may additionally indicate a maximum and/or minimum amount of funds the donor is willing to contribute to a student attending an educational institution. The donor profile may additional include one or more donation criteria of the donor. As discussed above, student profiles may include student data including but not limited to a student identification, current photo of the student, student contact data, name of an educational institution the student has committed to attend, a major area of study, a minor area of study, transcript, financial status of the student, financial assistance requested for the student's education for a specific semester in the educational institution, background data, family data, community involvement, volunteer data, work experience, etc.

At block 304, a list of student clients and the student profiles corresponding to the student clients based on the search is generated. At block 306, the corresponding student profiles are ranked based on the student data provided in the student profiles. At block 308, the list of student clients, the corresponding student profiles and the corresponding ranking are sent to the donor client. At block 310, a selection of a student client among the list of student clients is received from the donor client. At block 312, the donation is processed for the selected student client. As discussed above, the donation is processed by verifying method of payment received from the donor client for the selected student. In one embodiment, in response to the verifying, payment for the donation is rendered directly to the educational institution that the student is attending. In one embodiment, in response to the verifying, processing logic renders payment to a debtor to pay off at least a portion of an educational loan to the student. In one embodiment, in response to the verifying, the donation is received for payment directly to the selected student. At block 314, the student profile for the selected student is updated based on the processed donation. In one embodiment, the processed donation reduces the requested financial assistance provided in the student data of the student client. At block 316, the processed donation is sent on behalf of the selected student client. In one embodiment, the processed donation is sent directly to the selected student client. In one embodiment, the processed donation is sent to the educational institution client. In one embodiment, the processed donation is sent to a debtor to pay off at least a portion of an educational loan to the student. In one embodiment, the selected student client is notified of the processed donation sent to one of the educational institution client or the debtor. In one embodiment, the selected student client is notified of the update in the student profile. In one embodiment, the educational institution client is notified of the update in the student profile. In one embodiment, the donor client is notified of the update in the student profile.

FIG. 3B is a flow chart illustrating a method 320 for providing automated online donation services for a student associated with an educational institution education in accordance with an embodiment of the present invention. Method 320 may be performed by processing logic that may comprise hardware (e.g., circuitry, dedicated logic, programmable logic, microcode, etc.), software (such as instructions run on a processing device), firmware, or a combination thereof. In one embodiment, the method 320 is performed by the service provider component 124 of FIG. 1 and FIG. 2.

The method 320 begins at block 322, where an update in a student profile is detected. In one embodiment, the student profile is updated by a student client. In one embodiment, the student profile is updated by an educational institution client. At block 324, it is determined that the updated student profile is for the student client selected for donation by the donor client. In one embodiment, the update in the student data may include a change in one of an educational institution a student client is enrolled to attend, major area of study, minor area of study, transcript, financial status of the student client, community involvement, volunteer experience, work experience, etc. At block 326, the updated donor profile is compared with donor criteria in a donor profile. At block 328, a decision is made whether the updated donor profile satisfies the donor criteria. When at block 328, it is determined that the updated donor profile satisfies the donor criteria, a processed donation is sent on behalf of the selected student client at block 330. When at block 328, it is determined that the updated donor profile does not satisfy the donor criteria, then at block 332, the student client is sent a warning for not satisfying the donor criteria and providing a grace period to the student client to satisfy the donor criteria. At block 334, the updated student profile is retrieved after the grace period. At block 336, a decision is made to determine whether the updated student profile satisfies the donor criteria after the grace period. Block 330 is repeated when it is determined at block 336 that the updated student profile satisfies the donor criteria after the grace period. At block 338, the donation is converted to a loan when it is determined at block 336 that the updated student profile does not satisfy the donor criteria after the grace period. At block 340, the loan is processed for the student client. In one embodiment, the donation processing module 240 provides the processed loan to the educational institution client 150 for the student client 140 for payment of future costs for the student for the educational expense. In one embodiment, the donation processing module 240 notifies the student client 140 of the conversion of the donation to the loan provided to the educational institution client 150. At block 342, the student profile for the student client is updated based on the processed loan. In one embodiment, the student client is notified of the update in the student profile. In one embodiment, the educational institution client is notified of the update in the student profile. In one embodiment, the donor client is notified of the update in the student profile. At block 344, the processed loan is sent on behalf of the student client. In one embodiment, the processed loan is sent directly to the student client. In one embodiment, the processed loan is sent to the educational institution client. In one embodiment, the processed loan is sent to a debtor to pay off at least a portion of an educational loan to the student. In one embodiment, the student client is notified of the processed loan sent to one of the educational institution client or the debtor.

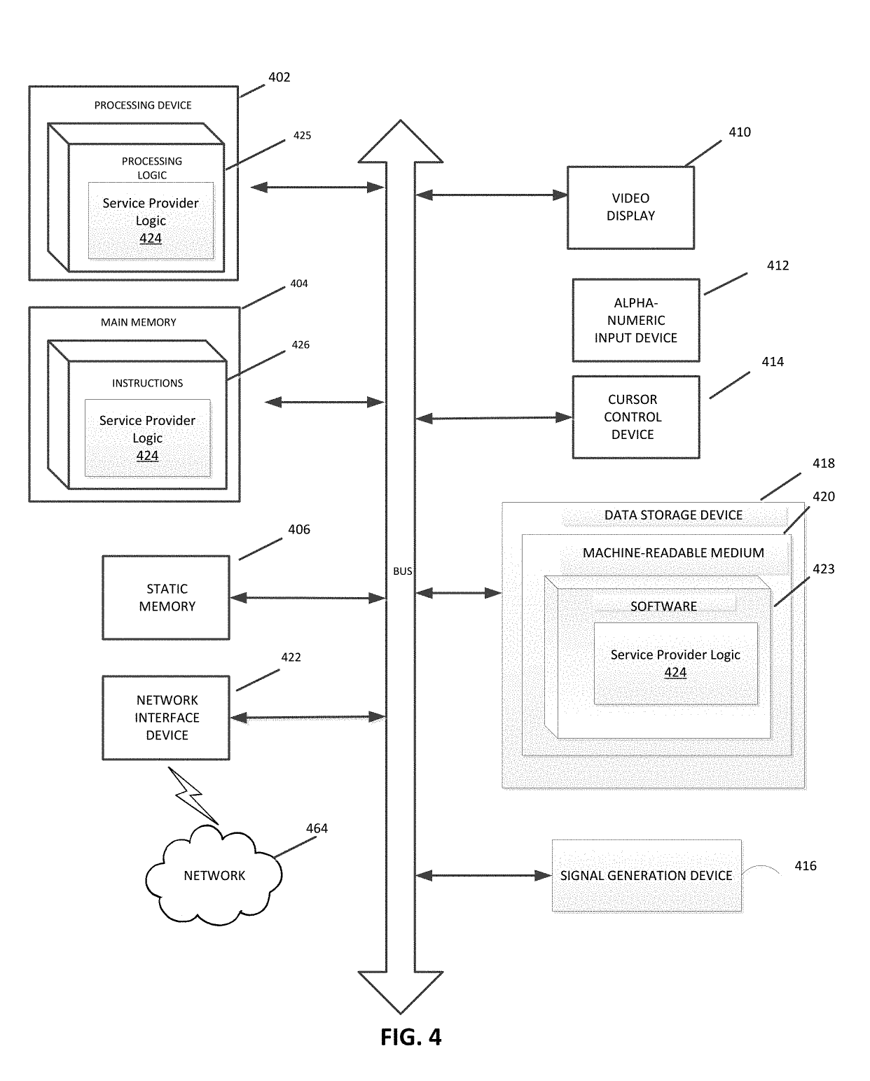

FIG. 4 illustrates a diagrammatic representation of a machine in the example form of a computer system 400 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a memory 404 (e.g., read-only memory (ROM), flash memory, dynamic random access memory (DRAM) (such as synchronous DRAM (SDRAM) or Rambus DRAM (RDRAM), etc.), a static memory 404 (e.g., flash memory, static random access memory (SRAM), etc.), and a data storage device 418, which communicate with each other via a bus 430.

Processing device 402 represents one or more general-purpose processing devices such as a microprocessor, central processing unit, or the like. More particularly, the processing device may be complex instruction set computing (CISC) microprocessor, reduced instruction set computer (RISC) microprocessor, long instruction word (VLIW) microprocessor, or processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. The processing device 402 is configured to execute service provider logic 424 for performing the operations and steps discussed herein. In one embodiment, service provider components 124 described with respect to FIG. 1 and FIG. 2, respectively, performs service provider logic 424.

The computer system 400 may further include a network interface device 408. The computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

The data storage device 418 may include a machine-accessible storage medium (or more specifically a computer-readable storage medium) 420 on which is stored one or more sets of instructions (e.g. service provider logic 424) embodying any one or more of the methodologies of functions described herein. The service provider logic 424 may also reside, completely or at least partially, within the memory 406 and/or within the processing device 402 during execution thereof by the computer system 400; the memory 406 and the processing device 402 constituting machine-accessible storage media. In one embodiment, service provider logic 424 is the same as the service provider component 124 of FIG. 1 and FIG. 2.

The machine-readable storage medium 420 may also be used to store the service provider logic 424 persistently containing methods that call the above applications. While the machine-readable storage medium 420 is shown in an example embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the disclosure. The term “machine-accessible storage medium” shall accordingly be taken to include, but not be limited to, solid-state memories, and optical and magnetic media.

In the foregoing description, numerous details are set forth. It should be apparent, however, that the disclosure may be practiced without these specific details. In some instances, structures and devices are shown in block diagram form, rather than in detail, in order to avoid obscuring the disclosure.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “determining”, “generating”, “receiving”, “processing”, “searching”, “providing”, “displaying”, “verifying” “updating”, “notifying”, “storing”, “converting”, “reducing” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such profile storage, transmission or display devices.

Embodiments of the present invention also relate to an apparatus for performing the operations herein. This apparatus may be specially constructed for the discussed purposes, or it may comprise a general purpose computer system selectively programmed by a computer program stored in the computer system. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

It is to be understood that the above description is intended to be illustrative, and not restrictive. Many other embodiments will be apparent to those well-known in the art upon reading and understanding the above description. Although the disclosure has been described with reference to specific examples of embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A method comprising:
searching, by the processing device, for a student data in a plurality of student profiles in a student database in view of one of a query received from a donor or information stored in a donor profile
generating, by the processing device, a list of students and corresponding student profiles in view of the search;
ranking the corresponding student profiles based on the student data in each of the corresponding student profiles;
sending the list of students, the corresponding student profiles and the corresponding ranking to the donor;
receiving, by the processing device, from the donor a selection of a student from the list of students; and
processing, by the processing device, a donation for the selected student.

2. The method of claim 1 wherein the student data comprises at least one of a student identification, student contact data, a name of an educational institution the student has committed to attend, a major area of study, a minor area of study, a transcript, student financial status, requested financial assistance for the student for a specific semester in the educational institution, background data, family data, community involvement, volunteer data or work experience data.

3. The method of claim 2 wherein processing the donation comprises at least one of:
a) providing the donation to an educational institution for the student; or
b) providing the donation to a debtor to pay off at least a portion of an educational loan to the student; or
c) providing the donation directly to the student.

4. The method of claim 3 further comprising reducing the requested financial assistance for the student in view of the processed donation.

5. The method of claim 1 further comprising:
updating the student profile in view of an update in the student data

6. The method of claim 5 further comprising determining whether the updated student profile satisfies a donor criterion in the donor profile.

7. The method of claim 6 further comprising converting the donation into a loan responsive to a determination that the updated student profile does not satisfy the donor criterion.

8. A system comprising:
a memory;
a processing device operatively coupled to the memory, to:
search for a student data in a plurality of student profiles in a student database in view of one of a query received from a donor or information stored in a donor profile
generate a list of students and corresponding student profiles in view of the search;
rank the corresponding student profiles based on the student data in each of the corresponding student profiles;
send the list of students, the corresponding student profiles and the corresponding ranking to the donor;
receive from the donor a selection of a student from the list of students; and
process a donation for the selected student.

9. The system of claim 8, wherein the student data comprises at least one of a student identification, student contact data, a name of an educational institution the student has committed to attend, a major area of study, a minor area of study, a transcript, student financial status, requested financial assistance for the student for a specific semester in the educational institution, background data, family data, community involvement, volunteer data or work experience data.

10. The system of claim 9, wherein to process the donation, the processing device is to at least one of:
a) provide the donation to an educational institution for the student; or
b) provide the donation to a debtor to pay off at least a portion of an educational loan to the student; or
c) provide the donation directly to the student.

11. The system of claim 10 wherein the processing device is to reduce the requested financial assistance for the student in view of the processed donation.

12. The system of claim 10 wherein the processing device is to update the student profile in view of an update in the student data.

13. The system of claim 12 wherein the processing device is to determine whether the updated student profile satisfies donor criteria in the donor profile.

14. The system of claim 13 wherein the processing device is to convert the donation into a loan in response to a determination that that the updated student profile does not satisfy the donor criteria.

15. A non-transitory machine-readable storage medium comprising instructions that, when accessed by a processing device cause the processing device to:
search for a student data in a plurality of student profiles in a student database in view of one of a query received from a donor or information stored in a donor profile
generate a list of students and corresponding student profiles in view of the search;
rank the corresponding student profiles based on the student data in each of the corresponding student profiles;
send the list of students, the corresponding student profiles and the corresponding ranking to the donor;
receive from the donor a selection of a student from the list of students; and
process a donation for the selected student.

16. The non-transitory machine-readable storage medium of claim 15, wherein the student data comprises at least one of a student identification, student contact data, a name of an educational institution the student has committed to attend, a major area of study, a minor area of study, a transcript, student financial status, requested financial assistance for the student for a specific semester in the educational institution, background data, family data, community involvement, volunteer data or work experience data.

17. The non-transitory machine-readable storage medium of claim 16, wherein to process the donation, the processing device is to at least one of:
a) provide the donation to an educational institution for the student; or
b) provide the donation to a debtor to pay off at least a portion of an educational loan to the student; or
c) provide the donation directly to the student.

18. The non-transitory machine-readable storage medium of claim 17 wherein the processing device is to reduce the requested financial assistance for the student in view of the processed donation.

19. The non-transitory machine-readable storage medium of claim 18 wherein the processing device is to update the student profile in view of an update in the student data.

20. The non-transitory machine-readable storage medium of claim 19, wherein the processing device is to:
determine whether the updated student profile satisfies donor criteria in the donor profile; and
convert the donation into a loan responsive to a determination that the updated student profile does not satisfy the donor criteria.
